(19) United States
(12) Patent Application Publication
(10) Pub. No.: US 2024/0313477 A1
(43) Pub. Date: Sep. 19, 2024

(54) CONNECTOR

(71) Applicant: Yamaichi Electronics Co., Ltd., Tokyo (JP)

(72) Inventors: Hiroaki KUKITA, Tokyo (JP); Miho Okubo, Tokyo (JP)

(21) Appl. No.: 18/608,569

(22) Filed: Mar. 18, 2024

(30) Foreign Application Priority Data
Mar. 17, 2023 (JP) 2023-042952

(51) Int. Cl. H01R 13/6471

(52) U.S. Cl. CPC H01R 13/6471

(57) ABSTRACT

Provided is a connector that can suppress resonance without using an additional component such as a conductive resin or a metal piece. A connector 1 includes: a pair of signal pins arranged in parallel and configured for differential transmission; a pair of ground pins 7G arranged in parallel on both sides of the pair of signal pins, respectively; and a housing 2 configured to accommodate the signal pins and the ground pins 7G, and a dielectric constant of surroundings of the ground pins 7G is smaller than a dielectric constant of surroundings of the signal pins.

### BACKGROUND

### 1. Technical Field

The present invention relates to a connector for differential transmission.

### 2. Description of Related Art

Widespread use of 5th Generation Mobile Communication System (5G), big data, artificial intelligence (AI), IoT, and the like have required faster and more stable communication of an enormous amount of data on the cloud.

For example, connectors compatible with 112 Gbps data transmission using Pulse Amplitude Modulation 4-level (PAM4) have been developed. In such high-speed transmission connectors, ground contacts (G) are arranged on both lateral sides of a pair of signal contacts (S) used for differential transmission, namely, arranged as with GSSG (see Japanese Patent Application Laid-Open No. 2020-187844).

Japanese Patent Application Laid-Open No. 2020-187844 is an example of the related art.

In a case of the coplanar structure in which a ground contact is arranged on the side of a signal contact, resonance may occur when the ground contact is coupled to the signal contact. To modify such resonance, a conceivable scheme is to use an additional component such as a conductive resin or a metal piece to shift the resonance frequency out of the required band.

However, the use of an additional component such as a conductive resin or a metal piece causes increased costs and complex manufacturing steps and, in addition, becomes an obstacle to a reduction in size and thickness of a product.

### BRIEF SUMMARY

The present invention has been made in view of such circumstances and intends to provide a connector that can suppress resonance without using an additional component such as a conductive resin or a metal piece.

A connector according to one aspect of the present invention includes: a pair of signal contacts arranged in parallel and configured for differential transmission; a pair of ground contacts arranged in parallel on both sides of the pair of signal contacts, respectively; and a housing configured to accommodate the signal contacts and the ground contacts, and the dielectric constant (the relative permittivity) of surroundings of the ground contacts is smaller than the dielectric constant of surroundings of the signal contacts.

It is possible to suppress resonance by making the dielectric constant of the surrounding of the signal contact different from the dielectric constant of the surrounding of the ground contact to change the electrical lengths of the signal contact and the ground contact. The present inventors have found that it is possible to suppress resonance by making the dielectric constant of the surrounding of the ground contact smaller than the dielectric constant of the surrounding of the signal contact.

It is possible to change the dielectric constant of the surrounding of the contacts by changing the structure or the material property of the surroundings of the contacts, and it is thus possible to suppress resonance without using an additional component such as a conductive resin or a metal piece.

Note that the physical regions around the contacts that determine the dielectric constants are ranges where electromagnetic waves formed by transmission signals are present.

In the connector according to one aspect of the present invention, εₛ/ε_{g}, which is the ratio of the dielectric constant εₛ and the dielectric constant ε_{g}, is greater than or equal to 1.1 and less than or equal to 1.6, where εₛ denotes the dielectric constant of surroundings of the signal contacts and ε_{g} denotes the dielectric constant of surroundings of the ground contacts.

According to study, the present inventors have found that a predetermined range of the ratio (εₛ/ε_{g}) of the dielectric constant εₛ of the surrounding of the signal contact and the dielectric constant ε_{g} of the surrounding of the ground contact can effectively suppress resonance.

In the connector according to one aspect of the present invention, a shape of a resin present in the surroundings of the signal contacts and a shape of a space present in the surroundings of the signal contacts are different from a shape of a resin present in the surroundings of the ground contacts and a shape of a space present in the surroundings of the ground contacts.

With the use of different shapes of the resins and the spaces present in the surroundings of the contacts, it is possible to make the dielectric constants of the surrounding different.

In the connector according to one aspect of the present invention, the area of a resin in contact with the ground contact is smaller than the area of a resin in contact with the signal contact.

When the area in contact with the resin of the contacts is smaller, the space portion in contact with the contacts will be relatively larger, and therefore the dielectric constant will be larger. Accordingly, the area of the resin in contact with the signal contacts is made larger than the area of the resin in contact with the ground contacts, and thereby the dielectric constant of the surrounding of the ground contacts is made smaller than the dielectric constant of the surrounding of the signal contacts.

In the connector according to one aspect of the present invention, the space present in the surroundings of the ground contacts is larger than the space present in the surroundings of the signal contacts.

When the space present in the surrounding of the contacts is larger, the dielectric constant will be smaller. Accordingly, the space present in the surroundings of the ground contacts is made larger than the space present in the surrounding of the signal contacts. For example, the thickness of the resins in contact with the ground contacts is thinner than the thickness of the resins in contact with the signal contacts.

In the connector according to one aspect of the present invention, a space is formed on a side to which the signal contacts and/or the ground contacts are displaced. Thus, a space without a resin is formed on the so-called sliding side of the signal contacts and/or the ground contacts.

In the connector according to one aspect of the present invention, a space is formed on both sides of planar parts of the ground contacts, each of the ground contacts being formed in a plate shape. Thus, a space without a resin is formed on both sides (the top face side and the bottom face side) of the planar parts of the plate-like ground contacts.

In the connector according to one aspect of the present invention, the dielectric constant of a resin present in the surroundings of the ground contacts is smaller than the dielectric constant of a resin present in the surroundings of the signal contacts.

The dielectric constant of the surroundings of the ground contacts may be made smaller than the dielectric constant of the surroundings of the signal contacts by the use of different dielectric constants of the resins present in the surroundings of the contacts. For example, the types of liquid crystal polymer (LCP) used as resins forming the housing are made different.

In the connector according to one aspect of the present invention, the housing includes a first block member configured to accommodate and hold each of the signal contacts and a second block member configured to accommodate and hold each of the ground contacts.

Each signal contact and each ground contact are accommodated and held in different block members. Accordingly, the housing is configured by assembling these block members. When the block members accommodating and holding respective contacts have different dielectric constants, the housing whose dielectric constant is changed can be easily configured.

Resonance can be suppressed without the use of an additional component such as a conductive resin or a metal piece.

### BRIEF DESCRIPTION OF THE SEVERAL VIEWS OF THE DRAWINGS

FIG. 1 is a perspective view illustrating a connector according to one embodiment of the present invention.

FIG. 2 is an exploded perspective view of the connector of FIG. 1.

FIG. 3A is a sectional view taken along a cut line X-X of FIG. 1.

FIG. 3B is a sectional view taken along a cut line Y-Y of FIG. 1.

FIG. 4A is a perspective view of a housing when viewed from rear.

FIG. 4B is a partial enlarged perspective view around a vertical abutment part of FIG. 4A.

FIG. 5 is a partial enlarged back view of the connector illustrating contact regions of contact pins.

FIG. 6 is a graph illustrating insertion losses of the connector.

FIG. 7A is a graph illustrating crosstalk levels of a connector of reference examples.

FIG. 7B is a graph illustrating crosstalk levels of a connector of embodiments.

FIG. 8 is a perspective view illustrating definitions of NEXT1, NEXT2, and FEXT1.

FIG. 9 is a perspective view illustrating a calculation model around contact pins of a connector according to Examples.

FIG. 10 is a graph illustrating simulation results of the calculation model of FIG. 9.

FIG. 11A is a graph illustrating simulation results when the ratio of dielectric constants is changed.

FIG. 11B is a graph partially enlarged from the graph of FIG. 11A.

FIG. 12A is a perspective view illustrating a calculation model of Example 21.

FIG. 12B is a perspective view illustrating a calculation model of Example 22.

FIG. 13A is a graph illustrating simulation results of Example 21 and Example 22.

FIG. 13B is a graph partially enlarged from the graph of FIG. 13A.

FIG. 14 is a perspective view illustrating a calculation model of Example 31.

FIG. 15 is a graph illustrating a simulation result of Example 31.

### DETAILED DESCRIPTION

A connector according to one embodiment of the present invention will be described with reference to the drawings.

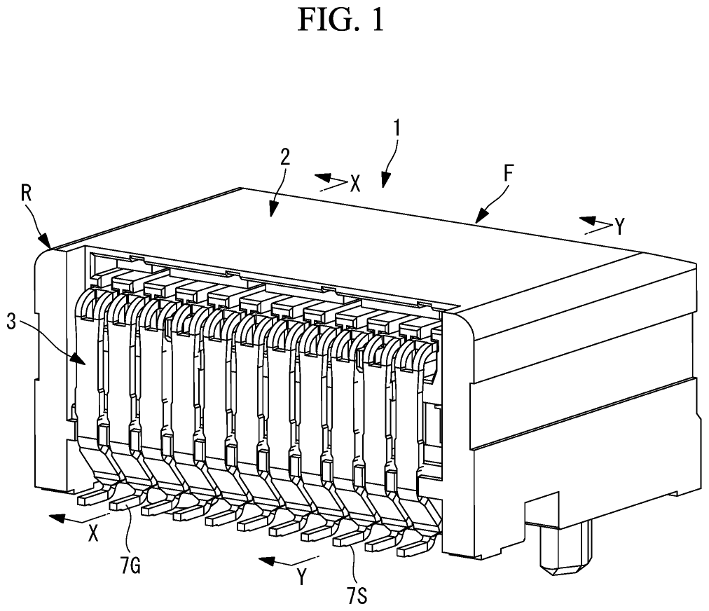

As illustrated in FIG. 1, a connector 1 of the present embodiment is used in a communication system such as a data center and is compatible with 112 Gbps data transmission using Pulse Amplitude Modulation 4-level (PAM4), for example. Note that the connector 1 of the present embodiment can also be used for data transmission above 112 Gbps.

In FIG. 1, the rear R side of the connector 1 is illustrated. The connector 1 is a connector that is mounted on a mount board thereunder (not illustrated), and a device is inserted into the connector from the front F side. Thus, the connector 1 is a connector that electrically connects the mount board and the device to each other. The device is an optical transceiver module, and an example of the connecting part to the connector is a circuit board having electrodes or a plug connector having contact pins.

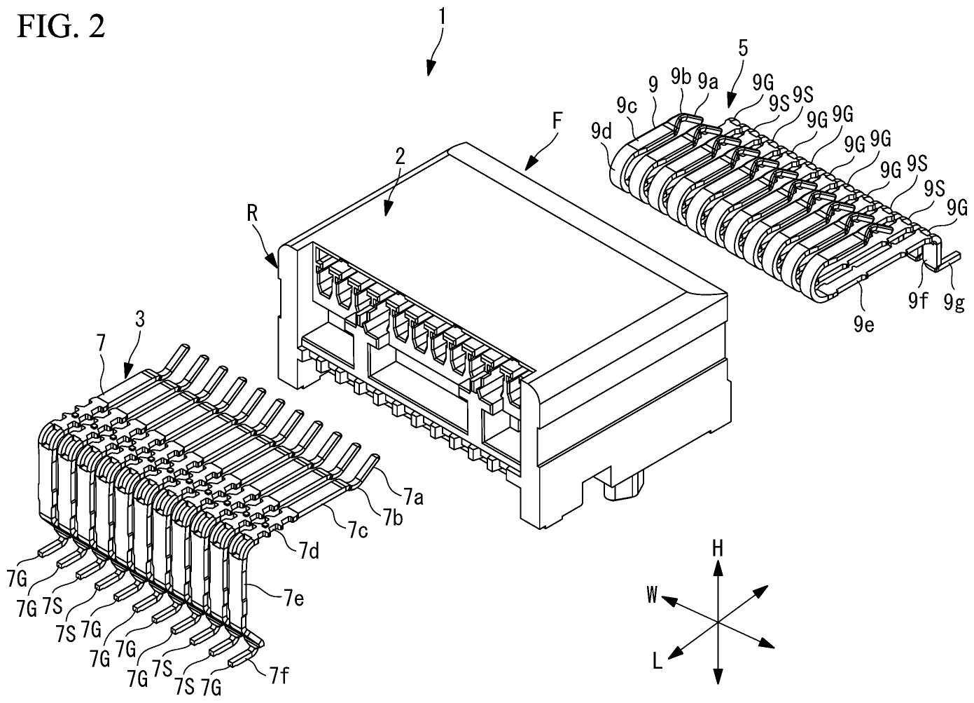

A part of a top pin group 3 is exposed on the rear R side of the connector 1. As illustrated in FIG. 2, the connector 1 includes a housing 2, the top pin group 3, and a bottom pin group 5.

The housing 2 is a component having a substantially rectangular parallelepiped external shape and accommodates and holds the top pin group 3 and the bottom pin group 5 located below the top pin group 3. The housing 2 is made of a nonconductive material such as a resin, and a liquid crystal polymer (LCP) is used, for example. The housing 2 is integrally molded using the same material.

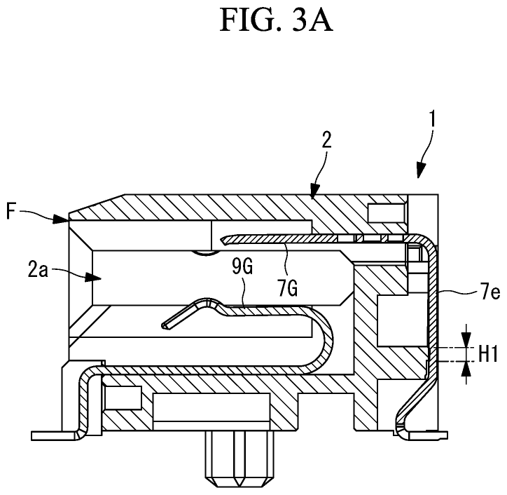

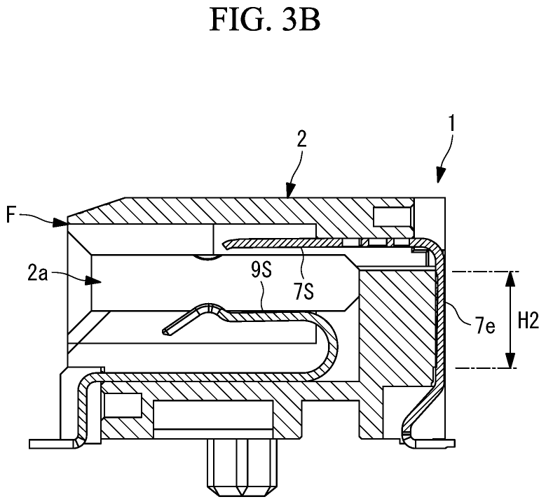

An insertion space 2a formed inside the housing 2 (see FIG. 3A and FIG. 3B) is opened in the front F of the housing 2. The tip side of the device having electrodes (not illustrated) is inserted into the insertion space 2a.

As illustrated in FIG. 2, the top pin group 3 is configured such that a plurality of contact pins 7 are aligned in the width direction W. Each contact pin 7 has a shape formed such that an elongated metal plate-like member extending in the longitudinal direction is bent at multiple positions. The extending direction of each contact pin 7 matches the insertion/extraction direction L of a device inserted into or extracted from the insertion space 2a of the housing 2. The top pin group 3 includes signal pins (signal contacts) 7S in which high-speed signals are transmitted and ground pins (ground contacts) 7G to be grounded. Some of the ground pins 7G are used as power supply pins used for powering. The signal pins 7S and the ground pins 7G are of the same shape.

The signal pins 7S serve as a differential pair, for example, and the ground pins 7G are provided on both lateral sides thereof in association with the differential pair, respectively. In FIG. 2, 11 pins are arranged in parallel in the order of GGSSGGGGSSG (G represents a ground, and S represents a signal, the same applies hereafter) from the left when viewed from the rear R side.

The contact pin 7 has a tip 7a, a contact part 7b, a spring beam part 7c, a press-fit part 7d, an erect part 7e, and a mount part 7f from the tip side to the base end side (the right to the left in FIG. 2).

The tip 7a is a straight part bent diagonally upward from the contact part 7b. The contact part 7b comes into electrical contact with an electrode of an inserted device. A spring beam part 7c is a straight portion to be electrically deformed in accordance with an operation to insert or extract a device. The press-fit part 7d is a portion press-fitted in and fixed to the housing 2 and has a plurality of protruding parts protruding in the width direction. The erect part 7e is a straight part bent substantially perpendicularly with respect to the press-fit part 7d and extending in the height direction H. The mount part 7f is fixed to a mount board (not illustrated) by soldering or the like.

The bottom pin group 5 is configured such that a plurality of contact pins 9 are aligned in the width direction W. Each contact pin 9 has a shape formed such that an elongated metal plate-like member extending in the longitudinal direction is bent at multiple positions. The extending direction of each contact pin 9 matches the insertion/extraction direction L of the housing 2.

The bottom pin group 5 includes signal pins (signal contacts) 9S in which high-speed signals are transmitted and ground pins (ground contacts) 9G to be grounded. Some of the ground pins 9G are used as power supply pins used for powering. The signal pins 9S and the ground pins 9G are of the same shape.

The signal pins 9S serve as a differential pair, for example, and the ground pins 9G are provided on both lateral sides thereof in association with the differential pair, respectively. In FIG. 2, 11 pins are arranged in parallel in the order of GSSGGGGGSSG from the left when viewed from the front F side. Note that it is also possible to arrange a control signal at the position of the center ground pins 7G, 9G of the top pin group 3 and the bottom pin group 5 and/or the position of the ground pin 7G at the end of the top pin group 3 (for example, the left when viewed from the rear R side).

The contact pin 9 of the bottom pin group 5 has a tip 9a, a contact part 9b, a parallel beam part 9c, a spring bending part 9d, a press-fit part 9e, an erect part 9f, and a mount part 9g from the tip side to the base end side.

The tip 9a is a straight part bent diagonally downward from the contact part 9b. The contact part 9b comes into electrical contact with an electrode of the device. The parallel beam part 9c has a substantially straight shape so as to be parallel to the device in a state before the device is inserted. The spring bending part 9d has a shape bent by about 180 degrees in order to arrange an external terminal in the insertion direction of the device. The press-fit part 9e is a portion press-fitted in and fixed to the housing 2 and has a plurality of protruding parts protruding in the width direction. The erect part 9f is a straight part bent substantially perpendicularly with respect to the press-fit part 9e and extending in the height direction H. The mount part 9g is fixed to a mount board (not illustrated) by soldering or the like.

As illustrated in FIG. 3A and FIG. 3B, the contact part 7b of the top pin group 3 is arranged so as to face the contact part 9b of the bottom pin group 5 in the insertion space 2a in a state where the top pin group 3 and the bottom pin group 5 are assembled in the housing 2.

FIG. 3A illustrates a sectional view taken along the cut line X-X of FIG. 1. Thus, FIG. 3A is a sectional view taken at a position corresponding to the ground pin 7G. FIG. 3B illustrates a sectional view taken along the cut line Y-Y of FIG. 1. Thus, FIG. 3B is a sectional view taken at a position corresponding to the signal pin 7S. As can be seen from comparison between FIG. 3A and FIG. 3B, there is a difference in the contact state of the erect part 7e of the contact pin 7 with the housing 2. Specifically, while only the region corresponding to the height dimension H1 of the erect part 7e is in contact with the resin of the housing 2 in the ground pin 7G of FIG. 3A, the region spanning the height dimension H2 (>H1) of the erect part 7e is in contact with the resin of the housing 2 in the signal pin 7S of FIG. 3B.

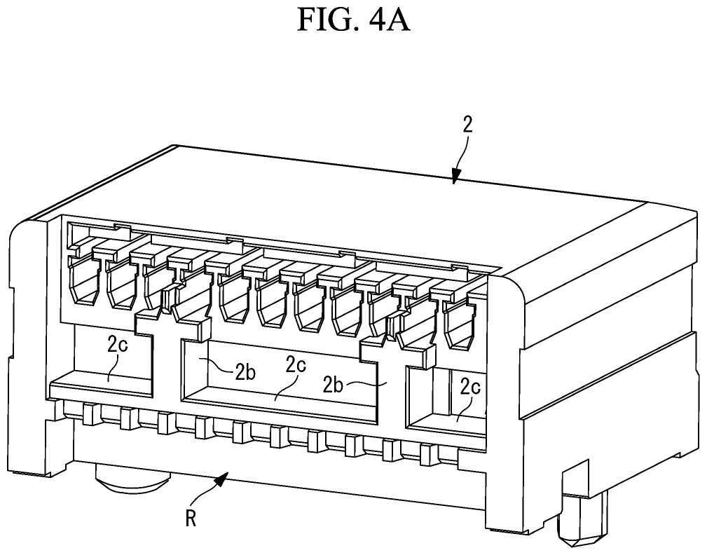

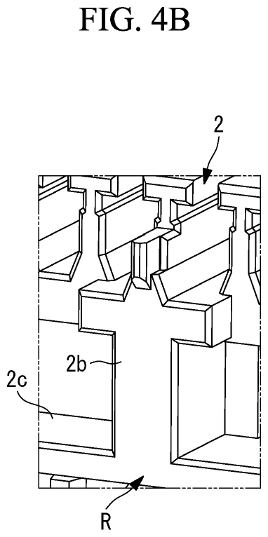

FIG. 4A illustrates the rear R side of the housing 2 in a state where the top pin group 3 (the contact pins 7) and the bottom pin group 5 (the contact pins 9) are removed. Vertical abutment parts 2b extending in the vertical direction are formed in an integrated manner at positions corresponding to the signal pins 7S on the back side of the housing 2. The vertical abutment part 2b extends upward from a lateral abutment part 2c extending in the width direction. FIG. 4B illustrates a part around the vertical abutment part 2b in enlarged view. Each vertical abutment part 2b is provided so as to be located at the center of a pair of signal pins 7S, and two vertical abutment parts 2b are provided in the present embodiment. The erect part 7e of the signal pin 7S comes into contact with the vertical abutment part 2b. Each lateral abutment part 2c comes into contact with both the signal pin 7S and the ground pin 7G.

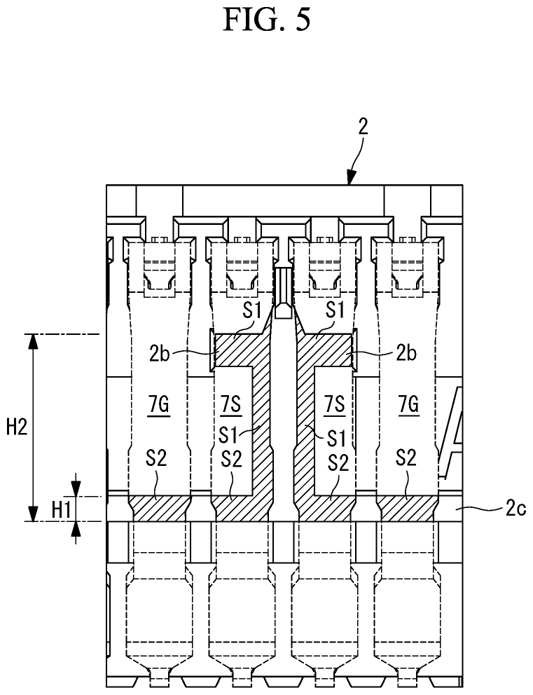

In FIG. 5, regions where the resins of the housing 2 are abutted against the contact pins 7 are hatched. As can be seen from FIG. 5, the resins are in contact with both the signal pins 7S and the ground pins 7G in the contact regions S2 by the lateral abutment parts 2c and are in contact with the signal pins 7S in the contact regions S1 by the vertical abutment parts 2b.

As discussed above, a larger area of the erect part 7e of the signal pin 7S is in contact with the resin of the housing 2 than that of the erect part 7e of the ground pin 7G. Further, in other regions of the contact pins 7, a contact state with the housing 2 and the shape of the resin and the shape of the space of the surroundings of the signal pins 7S and the ground pins 7G are the same. Therefore, the dielectric constant ε_{g} of the surrounding of the ground pin 7G is smaller than the dielectric constant εₛ of the surrounding of the signal pin 7S. Herein, the physical regions around the signal pin 7S and the ground pin 7G are ranges where electromagnetic waves formed by transmission signals are present.

It is preferable that the ratio (εₛ/ε_{g}) of the dielectric constants be greater than or equal to 1.1 and less than or equal to 1.6.

While depending on the wavelength of the transmission signal, the effect of suppressing resonance is obtained when the difference in dielectric constants of the contact pins 7 is set as described above in a range of a continuous section of 10% or greater, preferably 15% or greater of the entire length of the contact pin 7.

Note that, although the signal pin 7S and the ground pin 7G have basically the same shape, the dielectric constant of the surrounding of the contact pin 7 is changed as described above, and thus fine tuning of the shape for impedance adjustment is acceptable. The impedance adjustment is performed by changing the width or the thickness of the contact pin 7, for example.

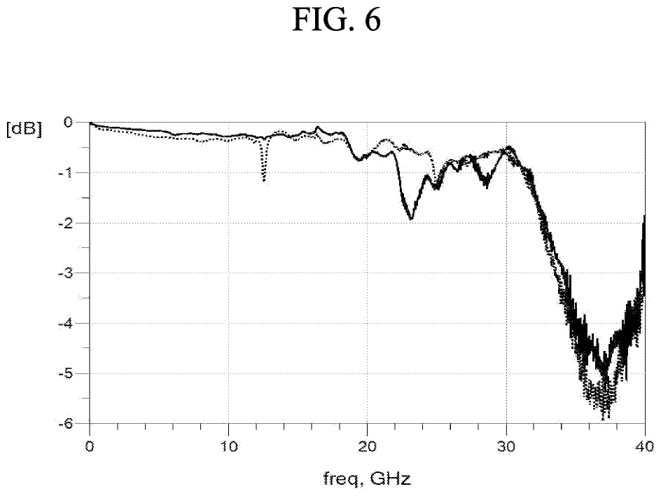

FIG. 6 illustrates experimental results when insertion losses of the connector 1 of the present embodiment and a connector of a reference example were measured. In FIG. 6, the horizontal axis represents frequency [GHz], and vertical axis represents insertion loss [dB]. The solid line represents the present embodiment, and the broken line represents the reference example. The reference example is a connector from which the vertical abutment parts 2b of the present embodiment are removed, and the contact states of the signal pins 7S and the ground pins 7G with the housing 2 are the same.

As can be seen from FIG. 6, the resonance (ripple) occurring around 12 GHz in the reference example (broken line) is suppressed in the present embodiment (solid line) to the degree that such resonance is hardly observed. Note that the insertion loss found around 23 GHz is due to impedance inconsistency and is not due to resonance.

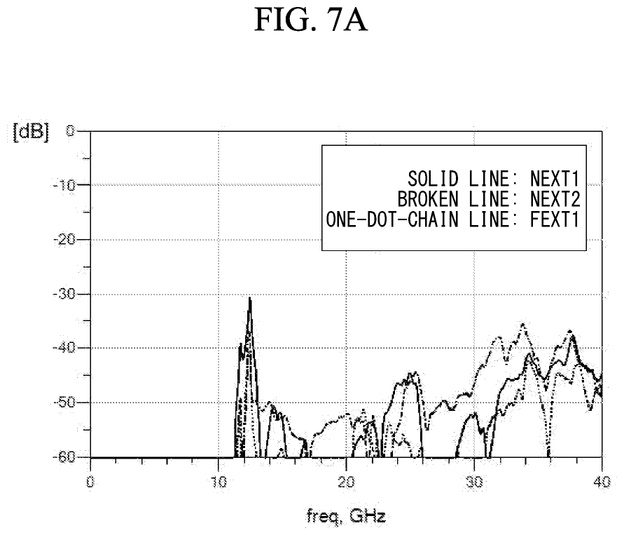

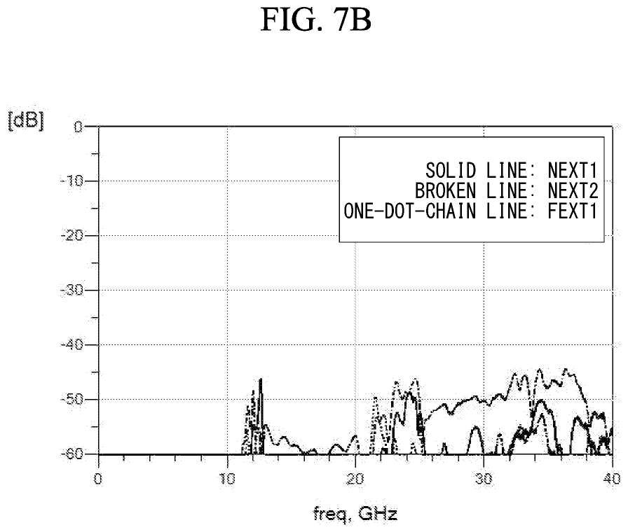

FIG. 7A and FIG. 7B illustrate experimental results when crosstalk levels of the connector 1 of the present embodiment and the connector of the reference example were measured. In FIG. 7A and FIG. 7B, the horizontal axis represents frequency [GHz], and vertical axis represents crosstalk level [dB]. The solid line represents NEXT1, the broken line represents NEXT2, and the one-dot-chain line represents FEXT1.

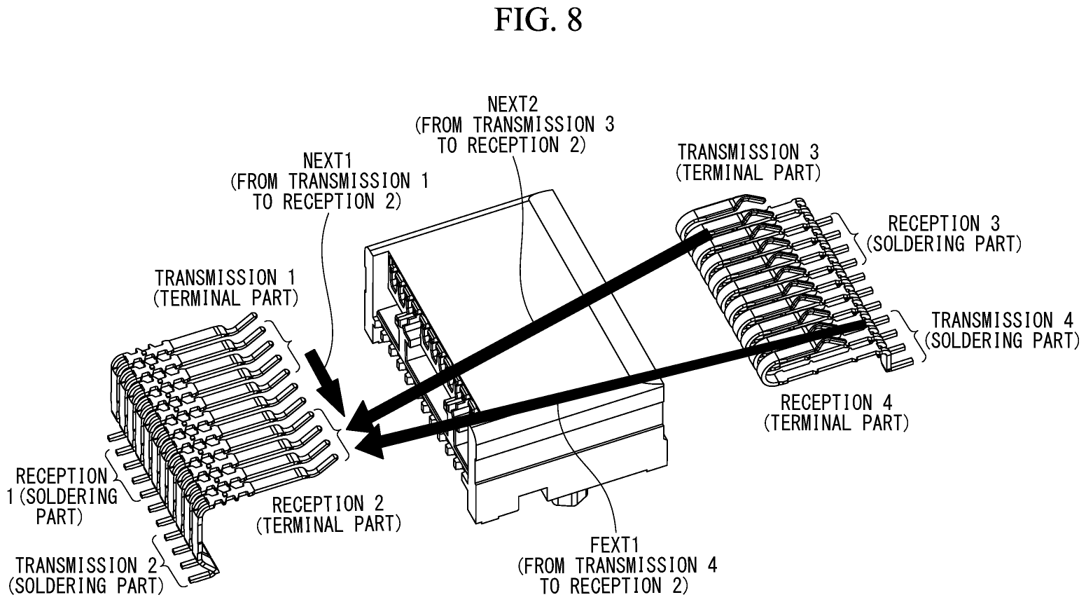

The definitions of NEXT1, NEXT2, and FEXT1 are as illustrated in FIG. 8. FIG. 8 illustrates the definitions when input is provided to transmission 2. The signal input to the transmission 2 is transmitted through contact pins and then signal-transmitted to an optical transceiver as an output signal (reception 2).

FIG. 7A illustrates crosstalk levels of the connector of reference examples, and about −30 dB of crosstalk occurs around 12 GHz in all of NEXT1, NEXT2, and FEXT1. In contrast, with reference to FIG. 7B illustrating the connector 1 of the present embodiment, the crosstalk level decreases to −45 dB around 12 GHz.

### EXAMPLES

Next, Examples of the present invention will be described with reference to the drawings. In the above embodiment, the contact area between the housing 2 and the contact pins 7 is changed in order to change the dielectric constant of the surrounding of the contact pins 7. In the present Examples, change in the dielectric constant and suppression of resonance in a case with the coplanar structure as with the connector 1 of the above embodiment were further examined.

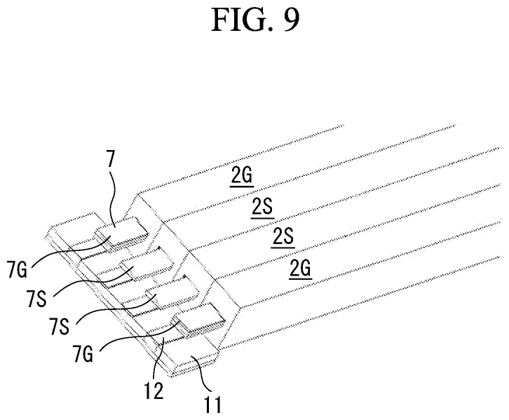

FIG. 9 illustrates a calculation model used for the simulation. As illustrated in FIG. 9, a pair of the signal pins 7S and the ground pins 7G provided on both lateral sides thereof are arranged in parallel. The resin parts 2S, which are a part of the housing 2, are formed around respective signal pins 7S, and the dielectric constant of the resin part 2S is denoted as εₛ. The resin parts 2G, which are a part of the housing 2, are formed around respective ground pins 7G, and the dielectric constant of the resin part 2G is denoted as ε_{g}. The tip of each of the contact pins 7 (the signal pins 7S and the ground pins 7G) is in contact with the pad 12 of the substrate 11. The length of each contact pin 7 is 50 mm. The resin parts 2S and the resin parts 2G were of the same shape. The range where the resin part 2S covers each signal pin 7S and the range where the resin part 2G covers each ground pin 7G are also the same.

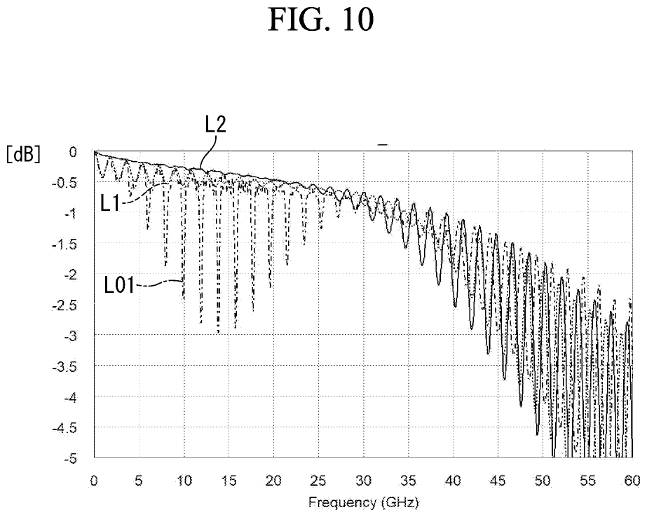

FIG. 10 illustrates simulation results of the calculation model illustrated in FIG. 9. In FIG. 10, the horizontal axis represents frequency [GHz], and vertical axis represents insertion loss [dB]. Comparative example 01 (L01) represents a case where both εₛ and ε_{g} are 3.1, Example 1 (L1) represents a case where εₛ is 3.1 and ε_{g} is 2.5 before impedance is adjusted, and Example 2 (L2) represents a case where εs is 3.1 and ε_{g} is 2.5 after impedance is adjusted. Thus, Comparative example 01 (L01) corresponds to a case where the dielectric constants of the surrounding of the signal pins 7S and the ground pins 7G are not changed, and Example 1 (L1) and Example 2 (L2) correspond to cases where the dielectric constant of the ground pins 7G is smaller than that of the signal pins 7S.

As can be seen from FIG. 10, while a plurality of resonance instances (ripples) occur at frequencies under 30 GHz in Comparative example 01 (L01), resonance is suppressed at frequencies under 30 GHz in Example 1 (L1) and Example 2 (L2). Further, since the impedance is adjusted in Example 2 (L2), the waveform is not wavy as with Example 1 (L1), and the reflection loss is suppressed.

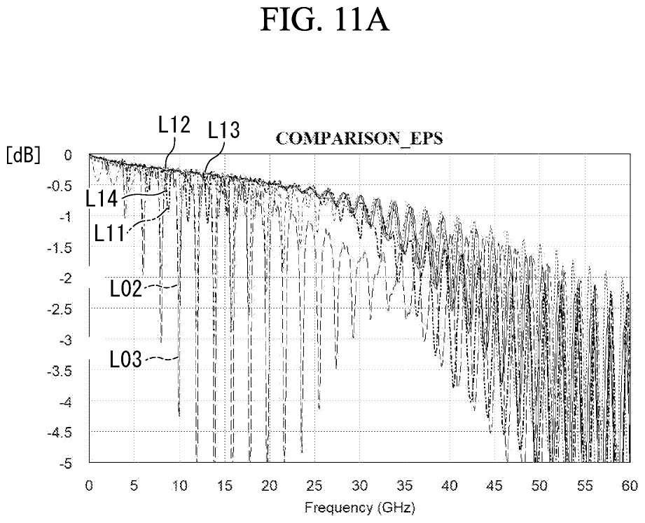

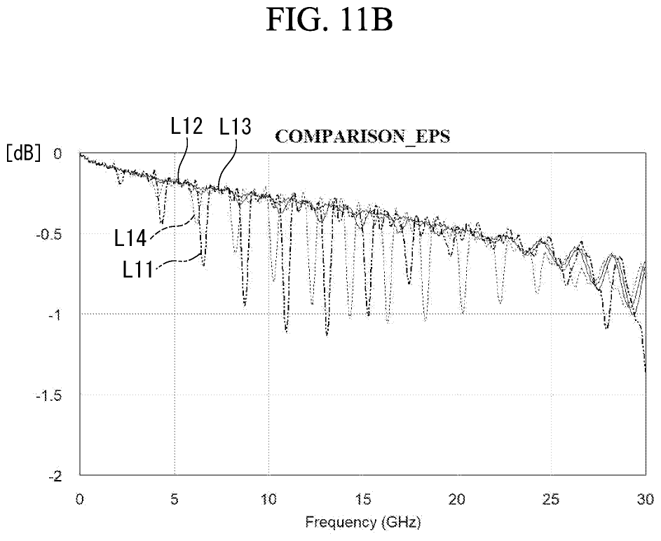

FIG. 11A illustrates simulation results when the ratio of εₛ and ε_{g}, which are dielectric constants, is changed. The vertical axis and the horizontal axis of FIG. 11A are the same as those of FIG. 10. The ratio of εₛ and ε_{g} is as listed in the following table.

TABLE 1

| | | | RATIO | |
|---|---|---|---|---|
| | εₛ | ε_{g} | (εₛ/ε_{g}) | EVALUATION |
| EXAMPLE 11 | 3.10 | 2.00 | 1.55 | ○ |
| (L11) | | | | |
| EXAMPLE 12 | 3.10 | 2.25 | 1.38 | ⊚ |
| (L12) | | | | |
| EXAMPLE 13 | 3.10 | 2.50 | 1.24 | ⊚ |
| (L13) | | | | |
| EXAMPLE 14 | 3.10 | 2.75 | 1.13 | ○ |
| (L14) | | | | |
| COMPARATIVE | 3.10 | 3.10 | 1.00 | x |
| EXAMPLE 02 | | | | |
| (L02) | | | | |
| COMPARATIVE | 3..10 | 3.35 | 0.93 | x |
| EXAMPLE 03 | | | | |
| (L03) | | | | |

FIG. 11B is a graph in which Comparative example 02 and Comparative example 03 are removed from FIG. 11A and whose horizontal axis and vertical axis are enlarged.

As can be seen from FIG. 11A and FIG. 11B, when the dielectric constant ε_{g} of the ground pin 7G is larger than the dielectric constant εₛ of the signal pin 7S, the resonance increases as with Comparative example 03 (L03). Contrarily, when the dielectric constant ε_{g} of the ground pin 7G is smaller than the dielectric constant εₛ of the signal pin 7S, the resonance decreases as with Examples 11, 12, 13, 14. Further, an appropriate range is also present for the ratio of the dielectric constants (εₛ/ε_{g}) and a range that is greater than or equal to 1.1 and less than or equal to 1.6 is preferable in accordance with determination from Examples 11, 12, 13, 14. Further, Examples 12 and 13 are the most preferable, and the ratio (εₛ/ε_{g}) is therefore more preferably greater than or equal to 1.2 and less than or equal to 1.4.

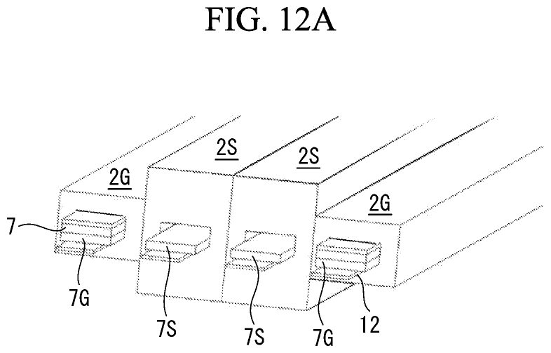

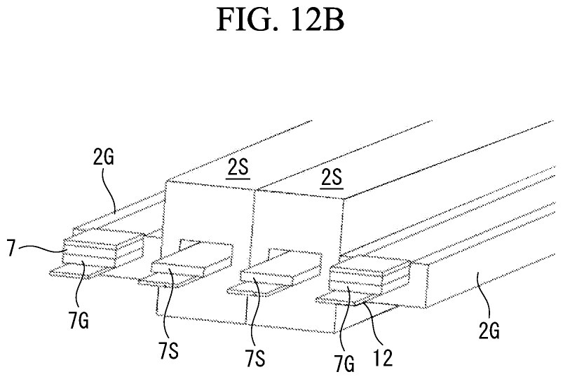

Next, a case where the entire surrounding of the contact pins 7 is not covered with a resin will be examined. The calculation model of FIG. 12A represents Example 21, and the thickness of the resin parts 2G above and below the ground pins 7G is thinner than that of the resin parts 2S of the signal pins 7S compared to the calculation model illustrated in FIG. 9. Thus, this is a case where air layers are formed over the resin parts 2G above the ground pins 7G and under the resin parts 2G below the ground pins 7G. The model of FIG. 12B represents Example 22, and this is a case where the resin parts 2G above the ground pins 7G are removed from Example 21 of FIG. 12A, and only the air layers are present above the ground pins 7G. Note that both the dielectric constant εₛ of the resin part 2S and the dielectric constant ε_{g} of the resin parts 2G are 3.1.

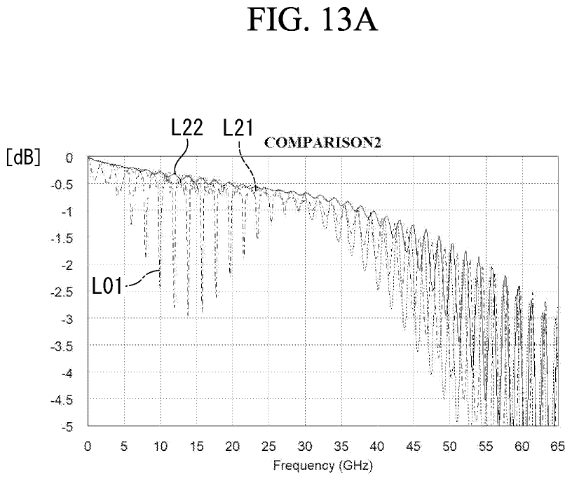

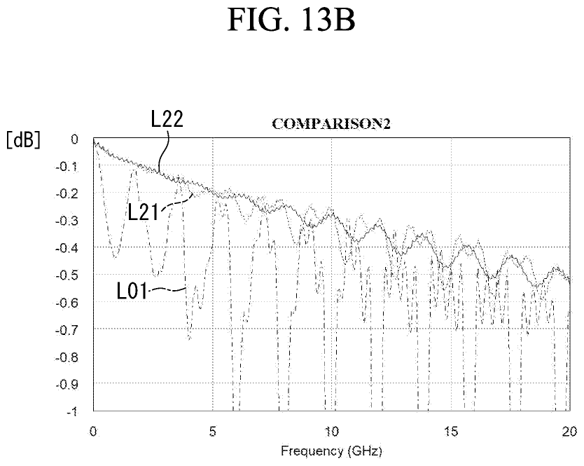

FIG. 13A illustrates simulation results of Example 21 (L21) and Example 22 (L22). In FIG. 13A, the horizontal axis represents frequency [GHz], and the vertical axis represents insertion loss [dB]. Comparative example 01 for the calculation model of FIG. 9 (L01: a case where both εₛ and ε_{g} are 3.1) is illustrated as a comparative example. FIG. 13B is a graph partially enlarged from the graph of FIG. 13A.

As can be seen from FIG. 13A and FIG. 13B, the resin parts 2G are thinned to add the air layers and reduce the dielectric constant around the ground pins 7G as with Example 21, and thereby the suppression effect on resonance (ripple) was observed. Further, when only the air layers are provided above the ground pins 7G as with Example 22, resonance was further suppressed, and only the reflection loss was observed. Thus, it is found from Example 21 and Example 22 that resonance can be suppressed even when the dielectric constant is changed by not only changing the area of the resin parts in contact with the contact pins 7 but also changing the structure around the contact pins 7.

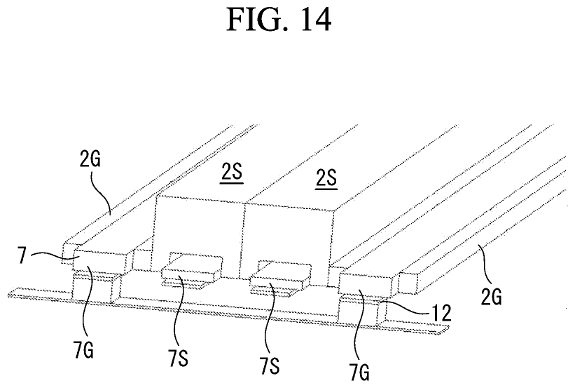

Next, as illustrated in the calculation model of FIG. 14 (Example 31), a shape provided for a case where the contact pins 7 slide was examined. As illustrated in FIG. 14, when the contact pins 7 slide, the portion below the signal pins 7S and the ground pins 7G is in the sliding direction, and thus there is no resin and is only an air layer in the portion. Example 31 is of a configuration in which the resin is further removed from Example 22 illustrated in FIG. 12B. Specifically, the resin parts 2S are present only above the signal pins 7S, and no resin and only the air layer is present above and below the ground pins 7G.

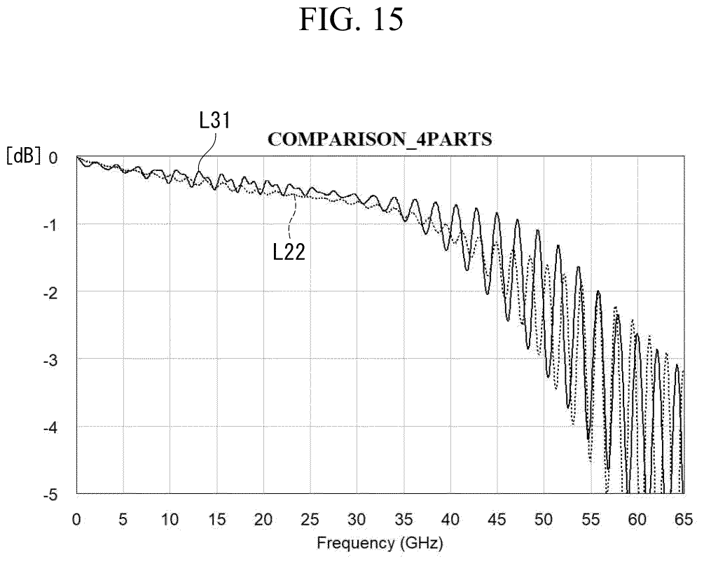

FIG. 15 illustrates a simulation result of Example 31 (L31). In FIG. 15, the horizontal axis represents frequency [GHz], and the vertical axis represents insertion loss [dB]. In addition, a simulation result of Example 22 (L22) is also illustrated. As can be seen from FIG. 15, resonance can be suppressed even when only the air layer is present below the contact pins 7 as with Example 31.

Effects and advantages of the present embodiment described above are as follows.

It is possible to suppress resonance by reducing the dielectric constant of a surrounding of the ground pins 7G to be smaller than the dielectric constant of a surrounding of the signal pins 7S. It is possible to change the dielectric constant of the surrounding of the contact pins 7 by changing the structure or the material property of the surrounding of the contact pins 7, and it is thus possible to suppress resonance without using an additional component such as a conductive resin or a metal piece.

According to the study, the present inventors have found that resonance can be effectively suppressed when the ratio (εₛ/ε_{g}) of the dielectric constant εₛ of the surrounding of the signal contact and the dielectric constant ε_{g} of the surrounding of the ground contact is in a range greater than or equal to 1.1 and less than or equal to 1.6.

By changing the shape of the resin present in the surrounding of the contact pins 7 and the shape of the space present in the surrounding of the contact pins 7, it is possible to control the dielectric constant of the surrounding of the contact pins 7.

When the area in contact with the resin of the contact pins 7 is smaller, the space portion in contact with the contact pins 7 will be relatively larger, and therefore the dielectric constant will be smaller. Accordingly, the area of the resin in contact with the signal pins 7S is made larger than the area of the resin in contact with the ground pins 7G, and thereby the dielectric constant of the surrounding of the ground pins 7G is made smaller than the dielectric constant of the surrounding of the signal pins 7S.

When the space present in the surrounding of the contact pins 7 is larger, the dielectric constant will be smaller. Accordingly, the space present in the surrounding of the ground pins 7G is made larger than the space present in the surrounding of the signal pins 7S. For example, the thickness of the resin in contact with the ground pins 7G is thinner than the thickness of the resin in contact with the signal pins 7S.

Further, the resin having a smaller dielectric constant than the resin present in the surroundings of the signal pin 7S is provided around the ground pins 7G, and thereby the dielectric constants of the surroundings of the contact pins 7 can be made different.

The dielectric constants of the surroundings in the contact pins 7 can be made different from each other by changing the shape of the resins also when the resin having a different dielectric constant from that of the resin present in the surroundings of the signal pins 7S is provided around the ground pins 7G. This is the same as the case where the dielectric constants are made different between the surrounding of the signal pins 7S and the surrounding of the ground pins 7G by changing the shape of resins having the same dielectric constant.

Note that, although a difference in the dielectric constant is provided for the top pin group 3 in the embodiment described above, a difference in the dielectric constant may also be provided for the bottom pin group 5.

Further, when the dielectric constants of the resin parts 2S, 2G are changed for each surrounding of the contact pins 7 as with FIG. 9 etc., the housing 2 can be formed of first block members each configured to accommodate and hold the corresponding signal pin 7S and second block members each configured to accommodate and hold the corresponding ground pin 7G. As such, each signal pin 7S and each ground pin 7G are accommodated and held in respective different block members, and the housing 2 is configured when these block members are assembled. Further, when the block members that accommodate and hold respective contacts have different dielectric constants, the housing 2 whose dielectric constant is changed can be easily formed.

Further, with the use of the common housing 2, block members whose dielectric constants are adjusted in accordance with application can be replaced with each other. The block members may be a type integrated with a contact pin or a type separated from a contact pin, and both of these types can be applied.

With the use of the first block member and the second block member having different shapes, the dielectric constants of surroundings of the contact pins 7 can also be made different.

The shape of each block member as with the resin part illustrated in FIG. 9 etc. may be a rectangular parallelepiped or may be a circular cylinder, and various forms may be taken.

It is possible to implement a change of the dielectric constant by using different types of liquid crystal polymer (LCP) used as a resin forming the housing 2, for example.

### List of Reference Symbols

1 connector

2 housing

2a insertion space

2b vertical abutment part

2c lateral abutment part

2G resin part

2S resin part

3 top pin group

5 bottom pin group

7 contact pin

7G ground pin (ground contact)

7S signal pin (signal contact)

7a tip

7b contact part

7c spring beam part

7d press-fit part

7e erect part

7f mount part

9 contact pin

9G ground pin (ground contact)

9S signal pin (signal contact)

9a tip

9b contact part

9c parallel beam part

9d spring bending part

9e press-fit part

9f erect part

9g mount part

11 substrate

12 pad

F front

H height direction

L insertion/extraction direction

R rear

S1 contact region

S2 contact region

W width direction

What is claimed is:

1. A connector comprising:
a pair of signal contacts arranged in parallel and configured for differential transmission;
a pair of ground contacts arranged in parallel on both sides of the pair of signal contacts, respectively; and
a housing configured to accommodate the signal contacts and the ground contacts,
wherein a dielectric constant of surroundings of the ground contacts is smaller than a dielectric constant of surroundings of the signal contacts.

2. The connector according to claim 1, wherein εₛ/ε_{g}, which is a ratio of the dielectric constant εₛ and the dielectric constant ε_{g}, is greater than or equal to 1.1 and less than or equal to 1.6, where εₛ denotes the dielectric constant of surroundings of the signal contacts and ε_{g} denotes the dielectric constant of surroundings of the ground contacts.

3. The connector according to claim 1, wherein a shape of a resin present in the surroundings of the signal contacts and a shape of a space present in the surroundings of the signal contacts are different from a shape of a resin present in the surroundings of the ground contacts and a shape of a space present in the surroundings of the ground contacts.

4. The connector according to claim 3, wherein an area of a resin in contact with the ground contact is smaller than an area of a resin in contact with the signal contact.

5. The connector according to claim 3, wherein the space present in the surroundings of the ground contacts is larger than the space present in the surroundings of the signal contacts.

6. The connector according to claim 5, wherein a space is formed on a side to which the signal contacts and/or the ground contacts are displaced.

7. The connector according to claim 5, wherein a space is formed on both lateral sides facing planar parts of the ground contacts, each of the ground contacts being formed in a plate shape.

8. The connector according to claim 1, wherein the dielectric constant of a resin present in the surroundings of the ground contacts is smaller than the dielectric constant of a resin present in the surroundings of the signal contacts.

9. The connector according to claim 1, wherein the housing comprises a first block member configured to accommodate and hold each of the signal contacts and a second block member configured to accommodate and hold each of the ground contacts.
